(19) United States
(12) Patent Application Publication
(10) Pub. No.: US 2013/0100262 A1
(43) Pub. Date: Apr. 25, 2013

(54) LOW-NOISE BIOCCULAR DIGITAL VISION DEVICE

(71) Applicant: Georges-Olivier Reymond, Paris (FR)

(72) Inventor: Georges-Olivier Reymond, Paris (FR)

(73) Assignee: SAGEM DEFENSE SECURITE, Paris (FR)

(21) Appl. No.: 13/807,885

(22) PCT Filed: Jun. 29, 2011
(86) PCT No.: PCT/EP2011/060926

§ 371 Date: Dec. 31, 2012

(30) Foreign Application Priority Data
Jul. 1, 2010 (FR) 1055312

(51) Int. Cl. H04N 7/00

(52) U.S. Cl. CPC H04N 7/002
USPC 348/61

(57) ABSTRACT

A binocular digital vision device comprising a digital processor member (2) connected firstly to a sensor (3) and secondly to two image playback elements (4.1, 4.2) of eyepieces (5.1, 5.2) for transmitting a digital video signal to each eyepiece, the device including a delay module (9) for establishing a time delay between the playback of images by the two eyepieces.

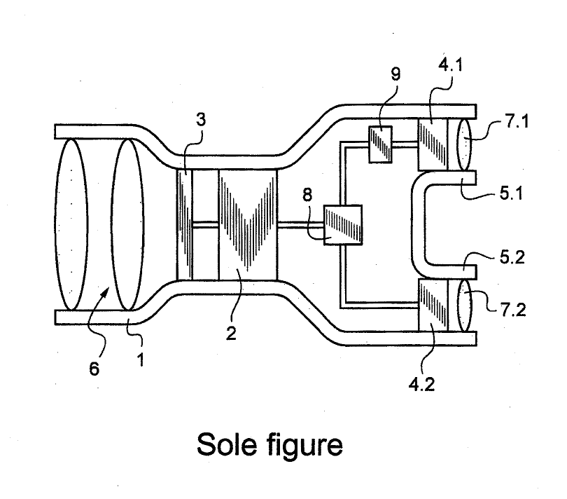

### FIELD OF THE INVENTION

The present invention relates to a binocular digital vision device such as binoculars and in particular night-vision binoculars.

### BACKGROUND OF THE INVENTION

Night-vision binoculars are known that have two optical channels, each having a light-intensifying sensor fitted with an image playback element such as a screen and associated with a set of lenses in order to form an eyepiece. A lens or a group of lenses is generally arranged in front of the sensor in order to provide an enlargement or magnifying effect.

With binoculars of this type, time-varying noise between the images played back by each eyepiece is independent and decorrelated. An observer's brain acts spontaneously to average the noise so that the image actually perceived by the observer presents noise that is reduced compared with the noise in the images presented to each of the eyes. This is equivalent to root mean square (rms) averaging and provides a theoretical improvement in the signal-to-noise ratio that is equivalent to a gain equal to the square root of two.

In order to reduce the weight and the size of binoculars, proposals have been made to provide binoculars that have only one optical channel as far as the sensor and then to split the single channel on its way to the eyepieces. Such binoculars then have only one sensor that is connected by a separator to each of the eyepieces. Such binoculars have only one group of lenses and possibly only one light intensifier.

The images played back by the eyepieces are then identical, and as a result the brain can no longer perform any averaging that serves to reduce the noise present in the images. It is then necessary to provide digital processing in order to reduce the noise o r to make use of a sensor of better quality, which is expensive.

### OBJECT AND SUMMARY OF THE INVENTION

An object of the invention is to obviate the above-mentioned drawbacks.

To this end, the invention provides a binocular digital vision device comprising a digital sensor connected to two image playback elements, each belonging to a respective eyepiece for transmitting a digital video signal to each eyepiece, the device comprising a delay module for establishing a time offset between the playback of images by the two eyepieces.

The same stream of images is sent to both eyepieces. Nevertheless, the images as perceived simultaneously by the right eye and by the left eye are different as a result of the time offset. These images are therefore affected by noise that is decorrelated. The brain can then use the images perceived simultaneously by the two eyes to perform averaging that serves to enable noise to be reduced by a factor equal to the square root of two. The device of the invention thus provides better vision of the images, in particular under difficult light conditions.

Preferably, the time offset is equivalent to at least one frame of the video signal and, advantageously, the video signal has a refresh rate lying in the range 25 hertz (Hz) to 60 Hz.

One frame suffices to obtain the desired effect, without the time offset being perceptible to the observer.

In a particular embodiment, the processor member is connected to the eyepieces by a signal separator, and the delay module is mounted between the signal separator and one of the eyepieces.

This embodiment is particularly simple.

The device may also include a digital processor member.

Advantageously, the device includes a stabilizer module and, preferably, the stabilizer module is incorporated in the processor member.

This makes it possible to compensate for shaking on the part of the observer that might otherwise give rise to a spatial offset between the images and thus to blurring perceivable by the observer.

According to a particular characteristic, the device includes a light intensifier mounted in front of the sensor.

### BRIEF DESCRIPTION OF THE DRAWING

Other characteristics and advantages of the invention appear on reading the following description of particular, non-limiting embodiments of the invention.

Reference is made to the sole accompanying FIGURE that is a diagram showing a vision device in accordance with the invention.

### MORE DETAILED DESCRIPTION

With reference to the FIGURE, the digital vision device of the invention is a binocular device comprising a housing 1 incorporating a digital processor member 2 that is connected firstly to a sensor 3 and secondly to two image playback elements 4.1 and 4.2 constituting eyepieces 5.1 and 5.2.

By way of example, the sensor 3 is a complementary metal-oxide semiconductor (CMOS) sensor or a charge-coupled device (CCD). In front of the sensor 3 there is arranged a group of lenses 6 for providing image-enlargement or a predetermined range of enlargements. Between the group of lenses 6 and the sensor 3, it is possible to install a light intensifier (not shown). The intensifier may be a light-intensifier tube or any other member arranged to amplify the light beam that has passed. through the group of lenses 6 so that the light beam that strikes the sensor 3 is of intensity that is increased relative to the light beam entering the device.

The image playback elements 4.1 and 4.2 are screens of the organic light-emitting diode (OLED) or the liquid crystal display (LCD) type having outlet lenses 7.1 and 7.2 placed in front of them. The distance between the screen and the outlet lens 7.1 or 7.2 is advantageously adjustable in order to be adaptable to the vision of the observer.

The processor member 2 is itself known and is arranged to transmit a digital video signal to the image playback element 4.1, 4.2 of each eyepiece 5.1, 5.2. The video signal has a refresh rate of 25 Hz for example. In this example the processor member 2 also incorporates a stabilizer module.

The processor member 2 is connected to the eyepieces 5.1 and 5.2 by a signal separator 8.

The device includes a delay module 9 connected between the signal separator 8 and the image playback element 4.1. The delay module 9 is arranged to establish a time offset between the images played back by the two eyepieces 5.1 and 5.2. The time offset is equal to at least one video frame. Thus, the image playback element 4.1 receives a video signal with a delay of one frame relative to the video signal received at the same instant by the image playback element 4.2.

Naturally, the invention is not limited to the embodiments described but covers any variant coming within the ambit of the invention as defined by the claims.

In particular, the device may be of a structure that is different from that described:
the separator is optional, the processor member may output two channels:
the delay module may be incorporated in the processor member or in the image playback element;
the processor member is optional and the sensor may be connected directly to the separator 8 and may possibly be arranged to perform processing on the signals; and
the device may optionally include a light intensifier, may operate with visible or infrared light, . . . .

The device may comprise binoculars or any other vision device having two eyepieces, e.g. a microscope.

What is claimed is:

1. A binocular digital vision device comprising a digital sensor connected to two image playback elements, each belonging to a respective eyepiece for transmitting a digital video signal to each eyepiece, wherein the device being characterized in that it includes a delay module for establishing a time offset between the playback of images by the two eyepieces.

2. The device according to claim 1, wherein the time offset is equivalent to at least one frame of the video signal.

3. The device according to claim 1, wherein the video signal has a refresh rate lying in the range 25 Hz to 60 Hz.

4. The device according to claim 1, including a digital processor member (2).

5. The device according to claim 4, wherein the processor member is connected to the eyepieces by a signal separator, and the delay module is mounted between the signal separator and one of the eyepieces.

6. The device according to claim 1, including a stabilizer module.

7. The device according claim 1, including a digital processor member and a stabilizer module, wherein the stabilizer module is incorporated in the processor member.

8. The device according to claim 1, including a light intensifier mounted in front of the sensor.
